(19) United States
(12) Patent Application Publication
(10) Pub. No.: US 2008/0202776 A1
(43) Pub. Date: Aug. 28, 2008

(54) FIRE AND SMOKE CONTROL SYSTEM FOR A LONG PASSAGE

(75) Inventors: Rong-Feng Tsai, Yunlin Hsien (TW); Ming-Chin Ho, Sindian City (TW)

Correspondence Address: PAI PATENT & TRADEMARK LAW FIRM, 1001 FOURTH AVENUE, SUITE 3200, SEATTLE, WA, 98154, US

(73) Assignee: AGRICULTURE AND BUILDING RESEARCH INSTITUTE, MINISTRY OF THE INTERIOR, R.O.C, Sindian City (TW)

(21) Appl. No.: 12/036,251

(22) Filed: Feb. 23, 2008

(30) Foreign Application Priority Data
Feb. 26, 2007 (TW) 96106507

(51) Int. Cl. A62C 2/08

(52) U.S. Cl. 169/48

(57) ABSTRACT

A fire and smoke control system for a long passage is utilized in a long passage with an inlet and an outlet. The fire and smoke control system for a long passage includes a first water spray curtain apparatus, a second water spray curtain apparatus, and at least one third water spray curtain apparatus. The first water spray curtain apparatus is fixed over the inlet, and the second water spray curtain apparatus is fixed over the outlet. The third water spray curtain apparatus is fixed on the top of the long passage between the inlet and the outlet to divide the long passage into several sections.

### RELATED APPLICATIONS

This application claims priority to Taiwan Application Serial Number 96106507, filed Feb. 26, 2007, which is herein incorporated by reference.

### BACKGROUND

1. Field of Invention

The present invention relates to a fire and smoke control system for a long passage, and more particularly to a fire and smoke control system of a long passage by using water spray.

2. Description of Related Art

Fire safety and smoke control systems are becoming important and much more important due to the increase in the size and number of high buildings of multi-functions. In general, a fire results in the form of heat, thermal radiation and smoke. The poisonous smoke due to incomplete combustion contains carbon dioxide (CO₂), carbon monoxide (CO), hydrocarbon (CₓH_{y}) and many solid particles, and is one of the most lethal factors to prevent human fleeing from the fire scenario.

In addition to the toxic carbon monoxide, some compounds of the poisonous smoke are flammable, and may result in flash over once the smoke concentration and temperature is raised to a critical level in a room or confined space. The occurrence of flash-over generally leads to serious damages to the human and properties in the fire scenario.

Nowadays, the size of civil buildings or public places is becoming huge and more complicated. However, the conventional fire control systems, based on the existing regulation, cannot promise the fire safety requirements for such buildings. A fire safety system must be able to extinguish fire and to delay the progress of fire so as to provide time and space for human flee and to reduce casualties.

Civil buildings such as a shopping mall, a hospital, a hotel, a tunnel and a subway are usually crowded with humans, and connected by long passages, which are customarily used as emergency exits when a fire or an accident occurs. Consequently, the upgrade of fire safety systems of a long passage becomes a very important issue of a public fire security, especially those related with human evacuation and reduction of smoke injury.

### SUMMARY

The aspect of the invention is therefore to provide a fire and smoke control system for a long passage to extend the evacuation period and reduce the casualties caused by smoke inhalation.

Accordingly, a fire and smoke control system for a long passage of the embodiment is applied to a long passage with an inlet and an outlet. The fire and smoke control system is composed of a plurality of water spray curtain apparatuses including a first water spray curtain apparatus, a second water spray curtain apparatus, and one or more than one third water spray curtain apparatus. The first water spray curtain apparatus is fixed over the inlet, and the second water spray curtain apparatus is fixed over the outlet. The third water spray curtain apparatuses are fixed on the top of the long passage between the inlet and the outlet, and divide the long passage into several sections. The fire and smoke control system further includes a water supply unit, which pump high pressure water to the first water spray curtain apparatus, the second water spray curtain apparatus and the third water spray curtain apparatuses. The fire and smoke control system further includes multiple control units to control and drive the first water spray curtain apparatus, the second water spray curtain apparatus and the third water spray curtain apparatuses.

The first water spray curtain apparatus, the second water spray curtain apparatus and each third water spray curtain apparatus respectively have one or more than one atomizers to generate water spray curtains. The injection angles of atomizers are vertical, horizontal or oblique, and the diameter of water spray ejected from the atomizers is in a range between 100-1000 μm or so. Moreover, the long passage includes an air-exhaust apparatus and multiple spraying apparatuses. The air-exhaust apparatus is used as an outlet of gases and smoke of the fire scenario. The spraying apparatuses may be mounted on the side walls at a height of between 20 and 50 centimeters from the ground.

As a result, the fire and smoke control system for a long passage in accordance with the present invention is of the following effects:

1. The fire and smoke control system can be applied to a tunnel, a subway, a shopping street or a corridor of a business building, hospital, hotel and a shopping mall etc. wherein the third water spray curtain apparatus divide the long passage into several sections to scrub smoke, to wet air, and to reduce air temperature and radiant heat transfer. Consequently, the system can largely reduce or stop the rate and scale of fire spread, prevent or postpone the flash over, and, therefore largely reduce casualties due to longer evacuation period.

2. The requirement of water quantity can also be largely reduced, compared with the conventional sprinkling or drenching device, since the ejected water spray of the present invention is of faster evaporation corresponding to more efficient heat absorption due to finer droplet sizes and more contact surface areas.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic view of a fire and smoke control system for a long passage of the embodiment in accordance with the present invention;

FIG. 2 is a schematic view of another fire and smoke control system for a long passage of the embodiment in accordance with the present invention; and

FIG. 3 is a schematic view of other fire and smoke control system for a long passage of the embodiment in accordance with the present invention.

### DESCRIPTION OF THE PREFERRED EMBODIMENTS

References will now be made in detail to the present preferred embodiments of the invention, examples of which are illustrated in the accompanying drawings. Wherever possible, the same reference numbers are used in the drawings and the description to refer to the same or similar parts.

While the specification concludes with claims defining the features of the invention that are regarded as novel, it is believed that the invention will be better understood from a consideration of the following description in conjunction with the figures, in which like reference numerals are carried forward.

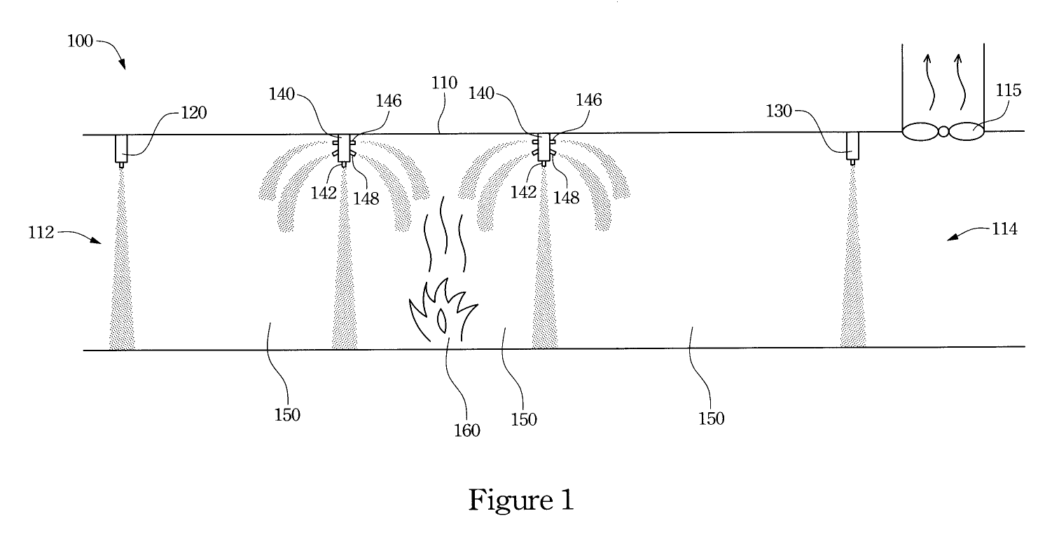

Refer to FIG. 1, which illustrates an embodiment of the fire and smoke control system for a long passage in accordance with the present invention. The fire control system 100 is applied to a long passage 110, such as an underground shopping street, or a corridor of a business building, hospital, hotel and a shopping mall. The long passage 110 includes an inlet 112 and an outlet 114. The fire and smoke control system 100 includes a first water spray curtain apparatus 120, a second water spray curtain apparatus 130 and one or more than one third water spray curtain apparatus 140. For conveniently illustrative purposes only, there are two third water spray curtain apparatus 140 shown in FIG. 1. The first water spray curtain apparatus 120 is fixed over the inlet 112. The second water spray curtain apparatus 130 is fixed over the outlet 114. The third water spray curtain apparatuses 140 are fixed on the top of the long passage 110 between the inlet 112 and the outlet 114.

When a fire occurs, the vertical atomizers 142 of the third water spray curtain apparatuses 140 eject the vertical water spray curtains to divide the long passage 110 into several sections 150. The vertical water spray curtains scrub smoke and decrease its diffusion rate, and such harmful smoke is, therefore, limited in a single section 150 with little leakage to neighboring section 150. Consequently, the casualties are largely reduced since the evacuation period is extended and firing area is limited. Each of the vertical atomizers 142 is of an ejecting angle between 55 and 85 degrees.

Each of the third water spray curtain apparatuses 140 includes horizontal atomizers 146 ejecting the horizontal water spray. Hot smoke rises and usually accumulates around the top of the long passage 110, the use of horizontal atomizers 146 can prevent flash over and reduce the diffusion of smoke since water spray moisturizes the smoke, and reduce its buoyancy by quenching down its temperature and increasing its weight. Each of the horizontal atomizers 146 is of an ejecting angle between 5 degrees and 35 degrees.

The fire source 160 generates an upward airflow due to thermal buoyancy, and creates a negative pressure close to the root of fire, into which the surrounding air can automatically flow due to pressure difference. Accordingly, the water spray ejected from the vertical atomizers 142 or the horizontal atomizers 146 is therefore drawn into the fire source 160 due to entrainment effect, and quenches the fuel vapor, airborne particles and by-products of combustion, due to heat absorption for water evaporation. The increase of moisture in the section 150 naturally leads to decreases of combustible fuel and temperature of fire reaction zone, the scale and spread rate of fire, and the risk of flash over by slowing down combustion reaction and decrease of oxygen supply due to water evaporation.

For a passage with an exhaust fan 115, the water spray curtain ejected from the first water spray curtain apparatus 120 fixed on the top of the inlet 112 moisturizes the coming-in air flowing into the long passage 110. The coming-in air of high moisture flows into the root of fire source 160 to quench down flame temperature, especially that close combustion reaction zone, and prevent the occurrence of flash over. The efficiency of such cooling does not only depend on the diameter of water spray but also the entrainment effect due to airflow. In accordance with the experiment, water droplets of diameters in the range between 100-1000 μm are effective since small droplets can follow the airflow but absorb little heat, and the big ones absorb large heat with slower response to the airflow.

The water spray curtain ejected from the second water spray curtain apparatus 130 fixed on the top of the air outlet 114 can moisture and scrub smoke to reduce the temperature and diffusion rate. As a result, the particles of smoke will be enclosed within the long passage 110, the spread of fire is stopped, and the collapse of exhaust pipe is prevented due to the reduction of exhausted air temperature.

The fire and smoke control system 100 includes a water supply unit set in the long passage 110 to supply the first water spray curtain apparatus 120, the second water spray curtain apparatus 130 and the third water spray curtain apparatuses 140. The fire and smoke control system for a long passage 100 further includes multiple controlling units respectively connected with the first water spray curtain apparatus 120, the second water spray curtain apparatus 130 and the third water spray curtain apparatuses 140. Each of the control units is of a sensing unit and a driving unit to detect the fire and start up the first water spray curtain apparatus 120, the second water spray curtain apparatus 130 and the third water spray curtain apparatuses 140. The fire and smoke control system 100 further includes an air-exhaust apparatus 115 located on the top of the long passage 110 and close to the air outlet 114.

The water spray curtains generated by the first water spray curtain apparatus 120, the second water spray curtain apparatus 130 and the third water spray curtain apparatuses 140 of the fire control system 100 does not necessarily inject toward the fire source 160 or enclose the fire source 160, but are purposely-designed to scrub smoke, reduce room temperature, and increase the moisture of air so as to control the scale of casualty in each section 150, and reduce the rates of smoke diffusion and fire spread. Moreover, each of the third water spray curtain apparatuses 140 of the fire control system 100 includes oblique atomizers 148 to obliquely eject water spray so as to increase liquid flux of water droplets surrounding the fire source 160, which is useful to control or extinguish fire by wetting the combustible materials and air.

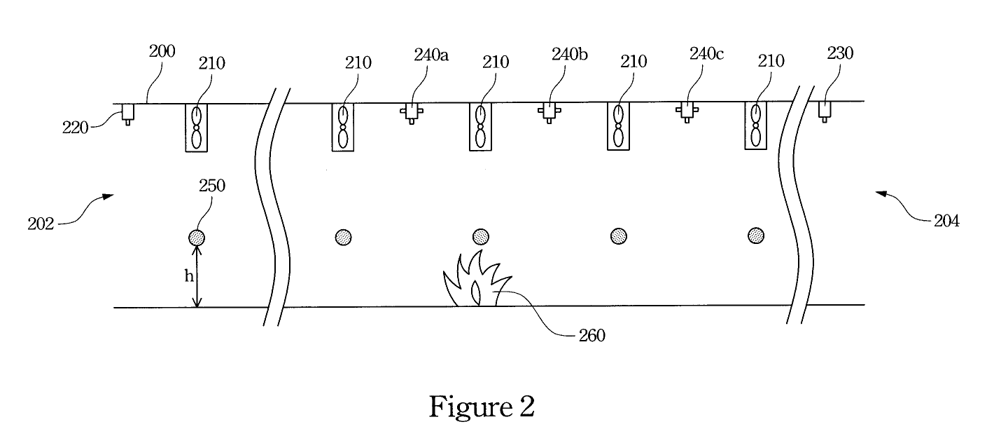

Refer to FIG. 2. FIG. 2 illustrates another embodiment of the fire and smoke control system for a long passage in accordance with the present invention. In this embodiment, the long passage is a tunnel 200 of the railway or highway. Most of tunnel fires are hidden fire since the fire sources are usually under the vehicle itself due to the leakage of gasoline or fuel. It is of little possibility to extinguish such hidden fire by direct ejection of water spray into the fire source by fixed fire fighting system since the relative position between the fire source and atomizer is of high uncertainty and the fire source is covered by the vehicle itself.

Besides the first water spray curtain apparatus 220, the second water spray curtain apparatus 230, and the third water spray curtain apparatuses 240, the fire control system further includes a plurality of spraying apparatuses 250 mounted on the side walls of the tunnel 200. Each of the spraying apparatuses 250 is located at a height h in the range between 20 and 50 centimeters from the ground. The spraying apparatuses 250 eject horizontally to lengthen the floating period of the water spray and can build a dense cloud of water spray close to the floor, which is highly possible to flow into the hidden fire source 260 due to air entrainment. The suppression efficiency of a hidden fire is, therefore, largely enhanced since its temperature is diminished, and its vaporized fuel and smoke are quenched and scrubbed. Consequently, the system related to the present invention can be used in a tunnel to extinguish hidden and open fire, and prevent flash over and the outward and upward diffusion of smoke, particularly useful to human flee.

The tunnel 200 usually includes multiple air-exhaust devices 210, with an interval of around 200 meters, to keep the running of airflow. The air-exhaust devices 210 forced the air flowing from the inlet 202 toward the outlet 204 of the tunnel 200. Based on the characteristics of airflow, the sensing unit of the third water spray curtain apparatus 240b firstly detects the fire when the fire source 260 occurs between the third water spray curtain apparatuses 240a and 240b. At the same time, the third water spray curtain apparatus 240a upstream to the fire source 260 is driven to eject water spray flowing toward the fire source 260 to decrease the temperature. In addition, the third water spray curtain apparatus 240b and the third water spray curtain apparatus 240c, downstream to the fire source 260, are also driven to not only decrease the temperature but also scrub and isolate the smoke.

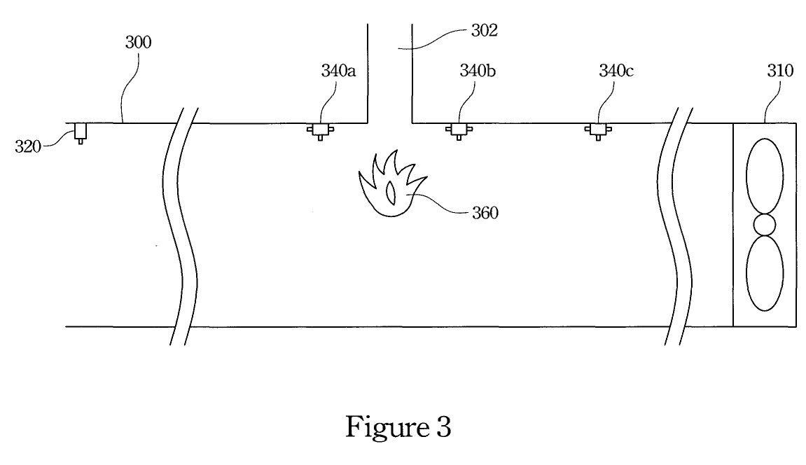

Refer to FIG. 3. FIG. 3 illustrates another embodiment of the fire and smoke control system for a long passage in accordance with the present invention. In this embodiment, the long passage is a large exhaust pipe 300 used in factories, and the gases in the exhaust pipe 300 contains flammable volatile organic compounds (VOCs). Accordingly, such fire hazard can be easily enlarged and burn down the whole area since combusting and flammable gases are transported to any place connected with exhaust pipe 300.

The exhaust pipe 300 includes an air-exhaust device 310 to expel air. When the fire occurs, the third water spray curtain apparatus 340 eject water spray toward the first water spray curtain apparatus 320 and adverse to the airflow within the exhaust pipe 300. The water spray adverse to the airflow can prevent the flame spread and extend the contact period between the water spray and the air to decrease the temperature in the exhaust pipe 300 and prevent the flame spread.

In addition, the exhaust pipe 300 includes multiple inlets for providing air in accordance with the extended length thereof. In the embodiment of FIG. 3, the fire source 360 occurs near the inlet 302, and the following third water spray curtain apparatuses 340b and 340c initially detect the fire and eject water spray toward the fire source 360, which are adverse to the airflow in the exhaust pipe 300. The third water spray curtain apparatus 340a upstream to the fire source 360 is also driven to eject the water spray to prevent the flame spread, flash over, and the diffusion of smoke, combusting and flammable gases.

The method divides the exhaust pipe 300 into several sections so as to confine the fire in a small range. In addition, the adverse ejection of water spray can effectively reduce the temperature of gases in the exhaust pipe 300 due to higher efficiency and longer period of mixing and heat transfer between the water spray and the combusting gases.

As embodied and broadly described herein, the fire and smoke control system for a long passage of the embodiments is of the following effects:

1. The first water spray curtain apparatus moisturizes the air flowing into the long passage. The second water spray curtain apparatus prevents the upward diffusion of smoke from the long passage. The vertical water sprays ejected from the third water spray curtain apparatuses divide the long passage into several sections to prevent the outward diffusion of smoke, and the horizontal water sprays ejected from the third water spray curtain apparatuses moisturize the risen smoke to reduce its temperature.

2. When the embodiment of the present invention is applied to a shopping street or a corridor of a business building etc., the third water spray curtain apparatus divides the long passage into several sections to extend the evacuation period for human flee and reduce casualties.

3. When the embodiment of the present invention is applied to a railway or a highway tunnel, the spraying apparatuses can build a dense cloud of water spray, which increases liquid flux of water droplets close to the floor and is particularly useful to extinguish a hidden fire.

4. When the embodiment of the present invention is applied to a huge exhaust pipe, the ejected water spray adverse to the airflow in the exhaust pipe prevents the flame spread, and extends the mixing period between the water spray and the combusting gases to decrease the temperature in the exhaust pipe.

5. Compared with the conventional sprinkler and drenching device, the water spray curtain apparatus of the embodiment requires less water, and the ejected water spray entrained by the airflow is evaporated through heat absorption such that the unnecessary water waste is avoided.

Although the present invention has been described in considerable detail with reference to certain preferred embodiments thereof, other embodiments are possible. Therefore, their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A fire and smoke control system for a long passage with an inlet and an outlet, comprising:
a first water spray curtain apparatus fixed over the inlet;
a second water spray curtain apparatus fixed over the outlet; and
at least one third water spray curtain apparatus fixed on a top of the long passage between the inlet and the outlet to divide the long passage into several sections.

2. The fire and smoke control system for a long passage of claim 1, wherein the first water spray curtain apparatus, the second water spray curtain apparatus and each third water spray curtain apparatus respectively comprise at least one atomizer to provide a water spray.

3. The fire and smoke control system for a long passage of claim 2, wherein each of the at least one atomizer comprises at least one vertical atomizer.

4. The fire and smoke control system for a long passage of claim 3, wherein each of the at least one vertical atomizer comprises an ejecting angle between 55 degrees and 85 degrees.

5. The fire and smoke control system for a long passage of claim 2, wherein each of the at least one atomizer comprises at least one horizontal atomizer.

6. The fire and smoke control system for a long passage of claim 5, wherein each of the at least one horizontal atomizer comprises an ejecting angle between 5 degrees and 35 degrees.

7. The fire and smoke control system for a long passage of claim 2, wherein each of the at least one atomizer comprises at least one oblique atomizer.

8. The fire and smoke control system for a long passage of claim 2, wherein the water spray in each water spray curtain comprises a water droplet diameter between 100-1000 μm.

9. The fire and smoke control system for a long passage of claim 1, further comprises an air-exhaust apparatus located on the top of the long passage.

10. The fire and smoke control system for a long passage of claim 1, further comprises multiple spraying apparatuses mounted on a side wall of the long passage.

11. The fire and smoke control system for a long passage of claim 10, wherein the spraying apparatuses are located at a height in the range between 20 and 50 centimeters from the ground.

12. The fire and smoke control system for a long passage of claim 11, wherein the long passage is a railway tunnel.

13. The fire and smoke control system for a long passage of claim 12, wherein the spraying apparatuses horizontally eject a water spray.

14. The fire and smoke control system for a long passage of claim 11, wherein the long passage is a huge exhaust pipe.

15. The fire and smoke control system for a long passage of claim 14, wherein the spraying apparatuses eject a water spray toward the first water spray curtain apparatus.

16. The fire and smoke control system for a long passage of claim 14, wherein the at least one third water spray curtain apparatuses ejects a water spray toward the first water spray curtain apparatus.
